(19) United States
(12) Patent Application Publication
(10) Pub. No.: US 2024/0258724 A1
(43) Pub. Date: Aug. 1, 2024

(54) TERMINAL FITTING

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Pipatthana PHATIWUTTIPAT, Mie (JP); Kenji MAKINO, Mie (JP)

(21) Appl. No.: 18/290,435

(22) PCT Filed: Mar. 23, 2022
(86) PCT No.: PCT/JP2022/013445

§ 371 Date: Nov. 13, 2023

(30) Foreign Application Priority Data
May 26, 2021 (JP) 2021-088058

(51) Int. Cl. H01R 12/59; H01R 12/69

(52) U.S. Cl. CPC H01R 12/592; H01R 12/69

(57) ABSTRACT

It is aimed to suppress the application of a tensile force to a connected part of a terminal fitting and a flexible printed board. A terminal fitting (10) is provided with a connecting portion (14) to be connected to a front end part (24) of a flexible printed wiring plate (20) and a fixing portion (16) located rearward of the connecting portion (14) in a rear end part (10A) and fixed to the flexible printed wiring plate (20).

### TECHNICAL FIELD

The present disclosure relates to a terminal fitting.

### BACKGROUND

A terminal fitting disclosed in Patent Document 1 is connected to a wiring of a printed wiring circuit having the wiring formed on a printed wiring board by ultrasonic welding or the like.

### PRIOR ART DOCUMENT

### Patent Document

Patent Document 1: JP 2002-260804 A

### SUMMARY OF THE INVENTION

### Problems to be Solved

In the terminal fitting of Patent Document 1, if the printed wiring board is pulled toward a side opposite to the terminal fitting, a tensile force directly acts on a connected part to the printed wiring board. Thus, the printed wiring board may be separated from the terminal fitting.

A terminal fitting of the present disclosure was completed on the basis of the above situation and can suppress the application of a tensile force to a connected part to a flexible printed board.

### Means to Solve the Problem

The present disclosure is directed to a terminal fitting with a connecting portion to be connected to a front end part of a flexible printed wiring plate, and a fixing portion located rearward of the connecting portion in a rear end part, the fixing portion being fixed to the flexible printed wiring plate.

### Effect of the Invention

According to the present disclosure, it is possible to suppress the application of a tensile force to a connected part of a terminal fitting and a flexible printed board.

### BRIEF DESCRIPTION OF THE DRAWINGS

FIG. 1 is a perspective view of a terminal fitting connected to a wiring plate when viewed from front.

FIG. 2 is a perspective view of the terminal fitting connected to the wiring plate when viewed from behind.

FIG. 3 is a side view of a part of the terminal fitting of FIG. 1 when viewed from right.

FIG. 4 is a plan view showing a part of the terminal fitting of FIG. 1.

FIG. 5 is a bottom view showing a part of the terminal fitting of FIG. 1.

FIG. 6 is a section along A-A of FIG. 4.

FIG. 7 is a section along B-B of FIG. 3.

FIG. 8 is a section along C-C of FIG. 3.

### DETAILED DESCRIPTION TO EXECUTE THE INVENTION

### Description of Embodiments of Present Disclosure

First, embodiments of the present disclosure are listed and described.

(1) The terminal fitting of the present disclosure is provided with a connecting portion to be connected to a front end part of a flexible printed wiring plate, and a fixing portion located rearward of the connecting portion in a rear end part, the fixing portion being fixed to the flexible printed wiring plate.

According to the configuration of the present disclosure, if the flexible printed wiring plate is pulled rearward, a tensile force acts on the entire terminal fitting via the fixing portion. Thus, it is possible to suppress the application of the tensile force to a connected part of the connecting portion and the flexible printed wiring plate. Thus, the separation of the flexible printed wiring plate from the connecting portion can be suppressed.

(2) Preferably, the flexible printed wiring plate is configured such that an electrically conductive path extends on one surface of a base member made of resin, the fixing portion includes a long portion in contact with the electrically conductive path and a short portion in contact with another surface of the base member, and the short portion bites into the other surface of the base member. According to this configuration, the short portion bites into the other surface of the base member made of resin, whereby a fixing force of the fixing portion to the flexible printed wiring plate is improved. Since the biting of the long portion into the flexible printed wiring plate is less than that of the short portion, the deformation of the electrically conductive path is suppressed.

(3) Preferably, the connecting portion includes a pair of side plate portions, an upper plate portion connected to upper end edges of the side plate portions and one lower plate portion linking lower end edges of the side plate portions, the fixing portion extends from the lower plate portion, the upper plate portion is constituted by a pair of connecting plate portions projecting from the pair of side plate portions via arcuate portions, projecting ends of the connecting plate portions butting against each other, the flexible printed wiring plate is connected to the pair of connecting plate portions, and a pair of the arcuate portions protrude outward from both left and right side edges of the flexible printed wiring plate. According to this configuration, since the arcuate portions protrude outward from the both left and right side edges of the flexible printed wiring plate, solder fillets easily contact the both left and right side edges of the flexible printed wiring plate and the arcuate portions in the connected part of the flexible printed wiring plate and the connecting portion. Thus, high connection strength between the flexible printed wiring plate and the connecting portion is obtained. Moreover, since the fixing portion extends from the lower plate portion in the form of a single plate, a width is easily secured.

(4) Preferably, the fixing portion includes a rising portion rising from the lower plate portion toward the flexible printed wiring plate and a supporting portion supporting the rising portion from behind. According to this configuration, if a tensile force acts on the flexible printed wiring plate, the rising portion is inclined rearward, but the inclination of the rising portion is suppressed by the supporting portion.

(5) Preferably, the fixing portion is made of a metal plate material and includes a base plate portion in contact with one surface of the flexible printed wiring plate and a crimping portion extending from the base plate portion, the crimping portion surrounding the flexible printed wiring plate, and the base plate portion has a double plate structure. According to this configuration, even if the metal plate material is thin in the fixing portion, rigidity can be enhanced and fixing strength can be improved by forming the base plate portion to have the double plate structure.

### Details of Embodiment of Present Disclosure

### Embodiment

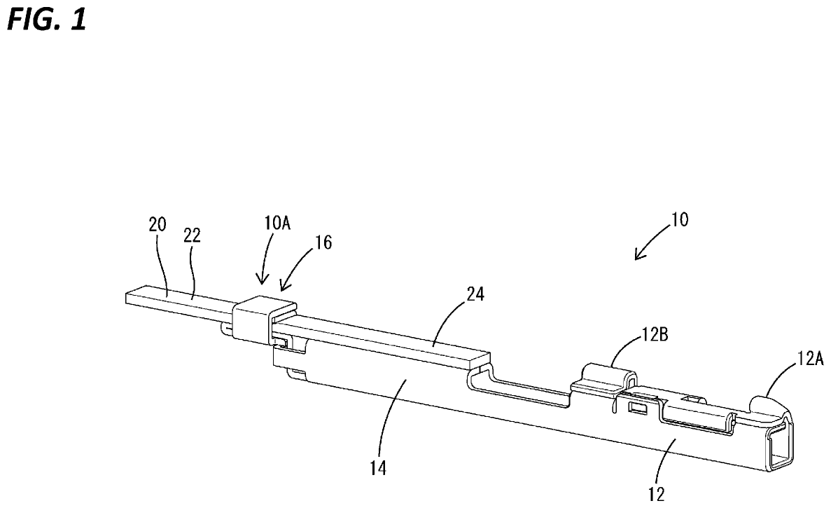

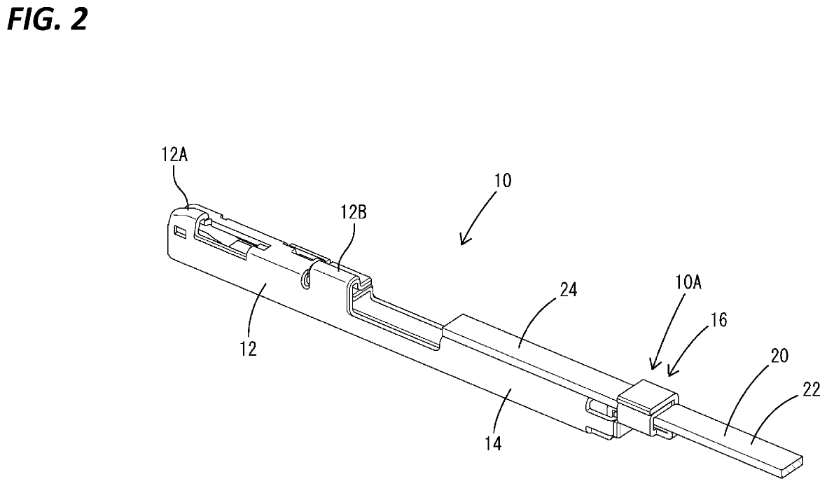

A specific embodiment of a terminal fitting of the present disclosure is described below with reference to FIGS. 1 to 8. Upper and lower sides shown in FIGS. 1 to 3 and 6 to 8 are directly defined as upper and lower sides concerning a vertical direction. Left and right sides shown in FIGS. 2 to 6 are respectively defined as front and rear sides concerning a front-rear direction. Front and rear sides shown in FIG. 1 are respectively defined as left and right sides concerning a lateral direction.

### Configuration of Terminal Fitting

A terminal fitting 10 of this embodiment shown in FIGS. 1 and 2 is connected to a flexible printed wiring plate (hereinafter, also merely referred to as a wiring plate) 20. The wiring plate 20 is configured such that an electrically conductive path (not shown) extends on one surface (lower surface) of a base member 22 made of resin. The base member 22 is, for example, constituted by a sheet made of insulating resin. The electrically conductive path is, for example, constituted by a copper foil. The wiring plate 20 is, for example, mounted into a connector housing (not shown) and constitutes a connector (not shown).

As shown in FIGS. 1 and 2, the wiring plate 20 is configured into a strip plate shape (strip shape). The terminal fitting 10 is connected to a front end side of the wiring plate 20.

As shown in FIGS. 1 and 2, the terminal fitting 10 is, for example, a female terminal fitting. The terminal fitting 10 is a single component made of a metal material. The terminal fitting 10 is formed, such as by pressing and bending an electrically conductive metal plate. The terminal fitting 10 has an elongated tube shape as a whole. The terminal fitting 10 is provided with a body portion 12, a connecting portion 14 and a fixing portion 16.

As shown in FIGS. 1 and 2, the body portion 12 is in the form of a rectangular tube hollow in the front-rear direction. A male tab (not shown) of a male terminal fitting is inserted into the body portion 12. The body portion 12 is, for example, provided with a first protrusion 12A and a second protrusion 12B. The first and second protrusions 12A, 12B are, for example, formed into a convex shape projecting upward by being pressed outward. For example, the first and second protrusions 12A, 12B function to restrict insertion when the terminal fitting 10 is inserted in an inverted posture into the connector housing (not shown) and prevent the terminal fitting 10 from coming out from the connector housing (not shown).

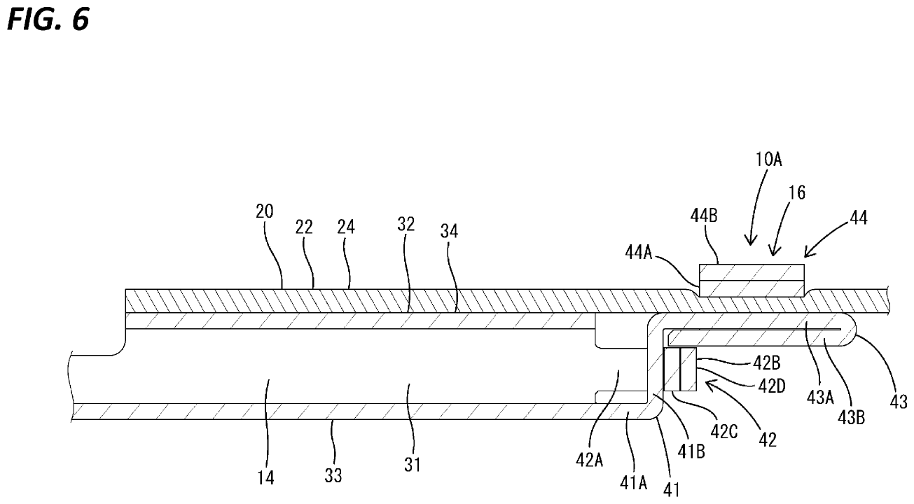

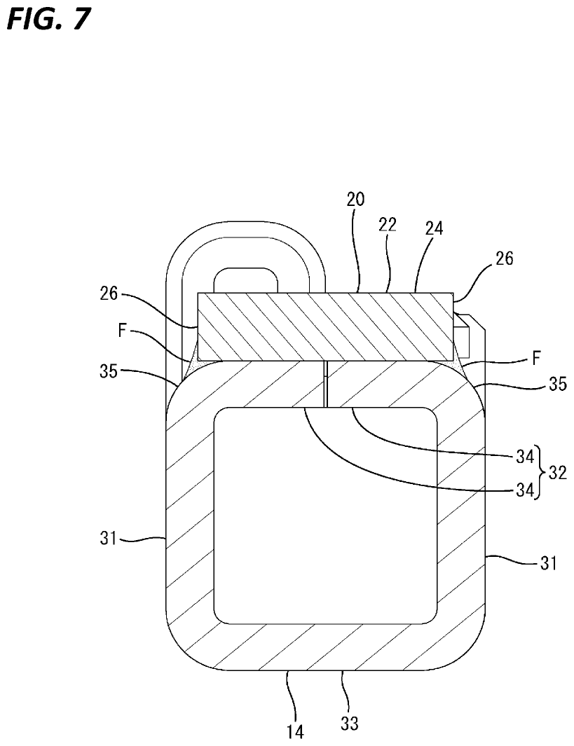

As shown in FIGS. 1 and 2, the connecting portion 14 is in the form of a rectangular tube hollow in the front-rear direction. The connecting portion 14 is located behind and away from the body portion 12. As shown in FIGS. 6 and 7, the connecting portion 14 includes a pair of side plate portions 31, an upper plate portion 32 and a lower plate portion 33. The side plate portion 31 is in the form of a single strip plate long in the front-rear direction. The upper plate portion 32 is connected to each of the upper end edges of the pair of side plate portions 31. The lower plate portion 33 is a single plate linking the lower end edges of the pair of side plate portions 31.

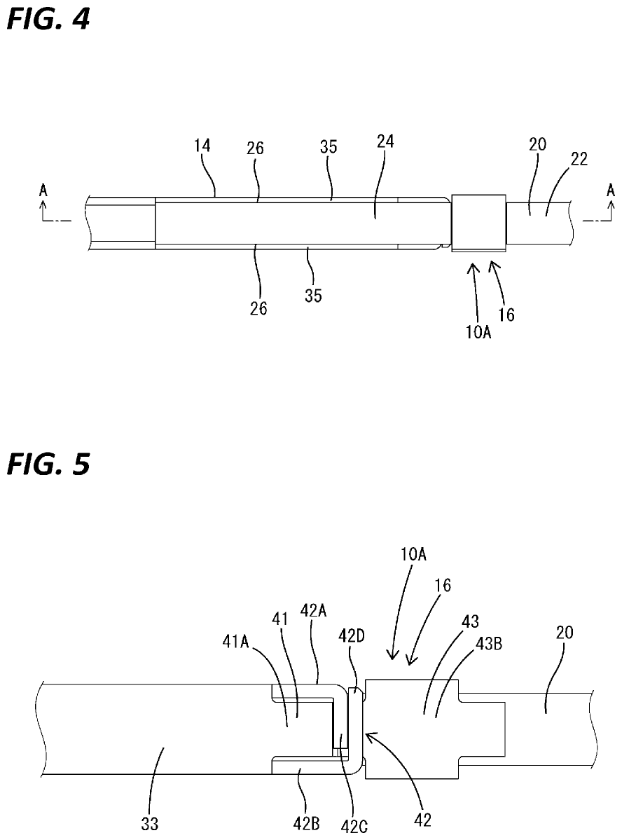

As shown in FIG. 7, the upper plate portion 32 is constituted by a pair of connecting plate portions 34. The connecting plate portion 34 projects from the upper end edge of the side plate portion 31 via an arcuate portion 35. As shown in FIGS. 4 and 7, the arcuate portions 35 protrude outward (laterally outward) from both left and right side edges of the wiring plate 20. The upper plate portion 32 is configured by causing the projecting ends of the pair of connecting plate portions 34 to butt against each other.

As shown in FIGS. 1 and 2, the connecting portion 14 is connected to a front end part 24 of the wiring plate 20. The connecting portion 14 is connected to the front end part 24 of the wiring plate 20, for example, by soldering. Specifically, as shown in FIG. 7, the upper plate portion 32 and the arcuate portions 35 of the connecting portion 14 are connected to the front end part 24 of the wiring plate 20. The upper surface of the upper plate portion 32 is substantially entirely connected to the front end part 24 of the wiring plate 20. Both left and right side edges 26 of the front end part 24 are respectively located at positions overlapping the left and right arcuate portions 35 in the vertical direction.

As shown in FIG. 7, solder fillets F are formed on the arcuate portions 35. The fillets F are formed over an interface between the lower surface of the front end part 24 of the wiring plate 20 and the upper surface of the upper plate portion 32. The fillets F are formed over the both left and right side edges 26 of the front end part 24 of the wiring plate 20 and the arcuate portions 35. Since the arcuate portions 35 protrude outward from the both left and right side edges 26 of the wiring plate 20, the fillets F easily contact the side surfaces (surfaces rising from the one surface (lower surface) of the base member 22) of the wiring plate 20 and the arcuate portions 35 in a connected part of the wiring plate 20 and the connecting portion 14. Thus, high connection strength between the wiring plate 20 and the connecting portion 14 is obtained.

As shown in FIGS. 1 to 6, the fixing portion 16 is provided in a rear end part 10A of the terminal fitting 10. The fixing portion 16 extends rearward from the rear end of the connecting portion 14 and is located rearward of the connecting portion 14. As shown in FIG. 6, the fixing portion 16 extends rearward from the lower plate portion 33 of the connecting portion 14. Since the fixing portion 16 extends from the lower plate portion 33 in the form of a single plate, a width is easily secured. The fixing portion 16 has a clip structure and is fixed to the wiring plate 20. If the wiring plate 20 is pulled rearward, a tensile force acts on the entire terminal fitting 10 via the fixing portion 16. Thus, it is possible to suppress the application of the tensile force to the connected part of the connecting portion 14 and the wiring plate 20. That is, an external force applied to the wiring plate 20 can be absorbed by the fixing portion 16. Thus, the separation of the wiring plate 20 from the connecting portion 14 can be suppressed.

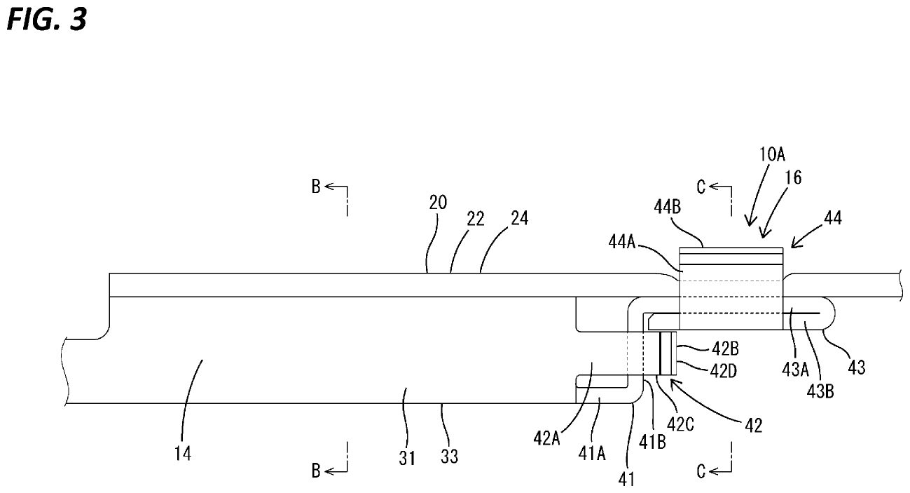

As shown in FIGS. 3 and 6, the fixing portion 16 includes a rising portion 41, a supporting portion 42, a base plate portion 43 and a crimping portion 44. The rising portion 41 rises toward the wiring plate 20 from the rear end of the lower plate portion 33 of the connecting portion 14. The rising portion 41 extends rearward from the lower plate portion 33 and then rises upward. The rising portion 41 includes a base end plate 41A and a rising plate 41B. The base end plate 41A extends rearward from the lower plate portion 33. The rising plate 41B rises upward (toward the wiring plate 20) from the rear end of the base end plate 41A.

As shown in FIGS. 3 and 6, the supporting portion 42 supports the rising portion 41 from behind. The supporting portion 42 includes a first support plate 42A and a second support plate 42B. The first support plate 42A extends rearward from the right side plate portion 31 and is further bent leftward. A rear side part 42C (part bent leftward) of the first support plate 42A is facing the rising plate 41B of the rising portion 41 from behind. Specifically, the rear side part 42C of the first support plate 42A contacts the rising plate 41B of the rising portion 41 from behind as shown in FIGS. 5 and 6. The second support plate 42B extends rearward from the left side plate portion 31 and is further bent rightward. A rear side part 42D (part bent rightward) of the second support plate 42B is facing the rear side part 42C of the first support plate 42A from behind. Specifically, the rear side part 42D of the second support plate 42B contacts the rear side part 42C of the first support plate 42A from behind. If a tensile force (tensile force acting rearward) acts on the wiring plate 20, the rising portion 41 is inclined rearward, but the inclination of the rising portion 41 is suppressed by the supporting portion 42.

The base plate portion 43 corresponds to an example of a “long portion” of the present invention. As shown in FIGS. 3 and 6, the base plate portion 43 has a double plate structure. Thus, even if the metal plate material is thin in the fixing portion 16, rigidity can be enhanced and fixing strength can be improved by forming the base plate portion 43 to have the double plate structure. The base plate portion 43 extends rearward from the upper end of the rising portion 41 (more specifically, the rising plate 41B), is further bent downward and extends forward. The upper surface of the base plate portion 43 is at the same height as that of the upper plate portion 32 of the connecting portion 14. The upper surface of the base plate portion 43 is parallel to that of the upper plate portion 32. That is, the upper surface of the base plate portion 43 and that of the upper plate portion 32 are flush with each other.

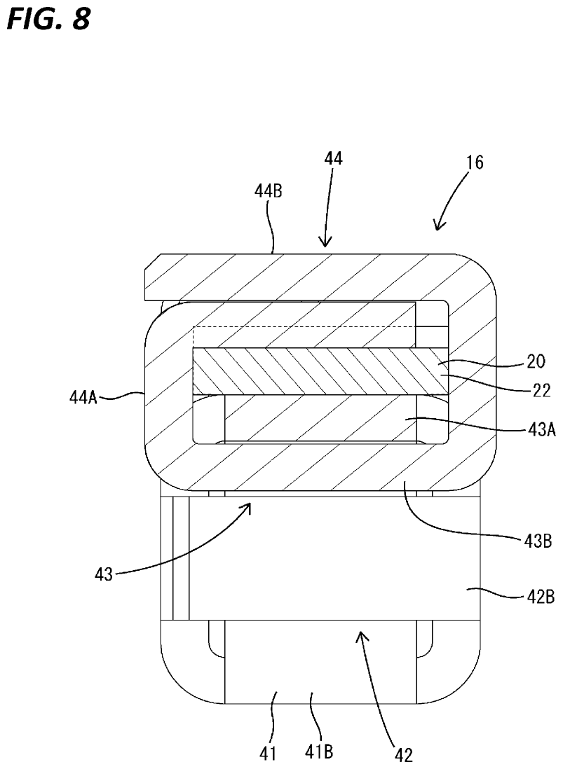

As shown in FIGS. 3 and 6, the base plate portion 43 includes an upper base plate 43A and a lower base plate 43B. The upper base plate 43A extends rearward from the upper end of the rising plate 41B. The base plate portion 43 is in contact with the electrically conductive path (not shown) of the wiring plate 20. The base plate portion 43 is in contact with the one surface (lower surface) of the wiring plate 20 (base member 22). A width in the lateral direction of the base plate portion 43 is smaller than that of the wiring plate 20 as shown in FIG. 8. As shown in FIGS. 3 and 6, the lower base plate 43B is connected to the front end of the upper base plate 43A and is folded with respect to the upper base plate 43A to extend forward. The lower base plate 43B is in contact with the lower surface of the upper base plate 43A. A width in the lateral direction of the lower base plate 43B is about equal to that of the upper base plate 43A. The tip (front end) of the lower base plate 43B is facing the rear surface of the rising plate 41B from behind. The tip (front end) of the lower base plate 43B is located above the supporting portion 42.

The crimping portion 44 corresponds to a “short portion” of the present invention. As shown in FIGS. 3 and 6, the crimping portion 44 extends from the lower base plate 43B of the base plate portion 43 and surrounds the wiring plate 20. The crimping portion 44 is in contact with the other surface (upper surface) of the base member 22 of the wiring plate 20. The crimping portion 44 bites into the other surface (upper surface) of the base member 22. Since the crimping portion 44 bites into the other surface (upper surface) of the base member 22 made of resin, a fixing force of the fixing portion 16 to the wiring plate 20 is improved. Since the biting of the base plate portion 43 into the wiring plate 20 is less than that of the crimping portion 44, the deformation of the electrically conductive path of the wiring plate 20 (electrically conductive path extending on the one surface (lower surface) of the base member 22) is suppressed.

As shown in FIGS. 3 and 8, the crimping portion 44 includes a first crimping plate 44A and a second crimping plate 44B. The first crimping plate 44A extends upward from a part of the right end of the lower base plate 43B, is further bent leftward and extends leftward. The first crimping plate 44A extends from a center in the front-rear direction of the right end of the lower base plate 43B. The left side surface of the base end (lower end) of the first crimping plate 44A is in contact with the right end surface of the base member 22. The tip (leftward extending part) of the first crimping plate 44A bites into the other surface (upper surface) of the base member 22 as shown in FIGS. 6 and 8.

As shown in FIG. 8, the second crimping plate 44B extends upward from a part of the left end of the lower base plate 43B, is further bent rightward and extends rightward. The second crimping plate 44B extends from a center in the front-rear direction of the left end of the lower base plate 43B. The right side surface of the base end (lower end) of the second crimping plate 44B is in contact with the left end surface of the base member 22. The tip (rightward extending part) of the second crimping plate 44B is in contact with the upper surface of the first crimping plate 44A.

The fixing portion 16 can be fixed to the wiring plate 20 in a state where the wiring plate 20 is not connected to the connecting portion 14. That is, after the wiring plate 20 is surrounded and fixed by the crimping portion 44, the connecting portion 14 can be connected to the front end part 24 of the wiring plate 20, for example, by soldering. In this way, the terminal fitting 10 can be positioned with respect to the wiring plate 20 and temporarily held before being connected to the wiring plate 20. As described above, since the upper surface of the base plate portion 43 and that of the upper plate portion 32 are flush with each other, the wiring plate 20 is easily connected to the connecting portion 14 after being temporarily held by the fixing portion 16.

### Effects of Embodiment

As described above, according to the terminal fitting 10 of the present disclosure, a tensile force acts on the entire terminal fitting 10 via the fixing portion 16 if the flexible printed wiring plate 20 is pulled rearward. Thus, it is possible to suppress the application of the tensile force to the connected part of the connecting portion 14 and the wiring plate 20. Thus, the separation of the wiring plate 20 from the connecting portion 14 can be suppressed.

In the terminal fitting 10 of the present disclosure, a fixing force of the fixing portion 16 to the wiring plate 20 is improved by the crimping portion 44 biting into the other surface (upper surface) of the base member 22 made of resin. Since the biting of the crimping portion 44 into the wiring plate 20 is less than that of the base plate portion 43, the deformation of the electrically conductive path is suppressed.

Since the arcuate portions 35 protrude outward from the both left and right side edges 26 of the wiring plate 20 in the terminal fitting 10 of the present disclosure, the solder fillets F easily contact the both left and right side edges 26 of the wiring plate 20 and the arcuate portions 35 in the connected part of the wiring plate 20 and the connecting portion 14. Thus, high connection strength between the wiring plate 20 and the connecting portion 14 is obtained. Moreover, since the fixing portion 16 extends from the lower plate portion 33 in the form of a single plate, the width is easily secured.

In the terminal fitting 10 of the present disclosure, the fixing portion 16 includes the supporting portion 42 for supporting the rising portion 41 from behind. Thus, if a tensile force acts on the wiring plate 20, the rising portion 41 is inclined rearward, but the inclination of the rising portion 41 is suppressed by the supporting portion 42.

In the terminal fitting 10 of the present disclosure, the base plate portion 43 has the double plate structure. Thus, even if the metal plate material is thin in the fixing portion 16, rigidity can be enhanced and fixing strength can be improved by forming the base plate portion 43 to have the double plate structure.

### Other Embodiments

The present invention is not limited to the above described and illustrated embodiment, but is represented by claims. The present invention is intended to include all changes in the scope of claims and in the meaning and scope of equivalents and also include the following embodiments.

Although the connecting portion 14 is connected to the front end part 24 of the wiring plate 20 by soldering in the above embodiment, the connecting portion 14 may be connected by another method (welding such as ultrasonic welding or the like).

Although the base plate portion 43 has the double plate structure in the above embodiment, the base plate portion 43 may be configured as a single plate.

Although the supporting portion 42 includes the first support plate 42A and the second support plate 42B in the above embodiment, only one of these support plates may be provided. That is, the rising portion 41 may be supported from behind by one support plate.

Although the crimping portion 44 includes the first crimping plate 44A and the second crimping plate 44B in the above embodiment, only one of these crimping plates may be provided. That is, one crimping plate may surround the wiring plate 20 and bite into the other surface (upper surface) of the base member 22.

### LIST OF REFERENCE NUMERALS

10 . . . terminal fitting
10A . . . rear end part
12 . . . body portion
12A . . . first protrusion
12B . . . second protrusion

1. A terminal fitting, comprising:
a connecting portion to be connected to a front end part of a flexible printed wiring plate; and
a fixing portion located rearward of the connecting portion in a rear end part, the fixing portion being fixed to the flexible printed wiring plate.

2. The terminal fitting of claim 1, wherein:
the flexible printed wiring plate is configured such that an electrically conductive path extends on one surface of a base member made of resin,
the fixing portion includes a long portion in contact with the electrically conductive path and a short portion in contact with another surface of the base member, and
the short portion bites into the other surface of the base member.

3. The terminal fitting of claim 1, wherein:
the connecting portion includes a pair of side plate portions, an upper plate portion connected to upper end edges of the side plate portions, and one lower plate portion linking lower end edges of the side plate portions,
the fixing portion extends from the lower plate portion,
the upper plate portion is constituted by a pair of connecting plate portions projecting from the pair of side plate portions via arcuate portions, projecting ends of the connecting plate portions butting against each other,
the flexible printed wiring plate is connected to the pair of connecting plate portions, and
a pair of the arcuate portions protrude outward from both left and right side edges of the flexible printed wiring plate.

4. The terminal fitting of claim 3, wherein the fixing portion includes:
a rising portion rising from the lower plate portion toward the flexible printed wiring plate; and
a supporting portion supporting the rising portion from behind.

5. The terminal fitting of claim 1, wherein:
the fixing portion is made of a metal plate material and includes:
a base plate portion in contact with one surface of the flexible printed wiring plate; and
a crimping portion extending from the base plate portion, the crimping portion surrounding the flexible printed wiring plate,
the base plate portion has a double plate structure.
